(19) United States
(12) Patent Application Publication
(10) Pub. No.: US 2017/0369824 A1
(43) Pub. Date: Dec. 28, 2017

(54) PORTIONED WASHING OR CLEANING AGENT COMPRISING MICROCAPSULES IN THE POWDER COMPARTMENT

(71) Applicant: Henkel AG & Co. KGaA, Duesseldorf (DE)

(72) Inventors: Matthias Sunder, Duesseldorf (DE); Frank Meier, Duesseldorf (DE); Mario Sturm, Leverkusen (DE)

(73) Assignee: Henkel AG & Co. KGaA, Duesseldorf (DE)

(21) Appl. No.: 15/696,792

(22) Filed: Sep. 6, 2017

Related U.S. Application Data
(63) Continuation of application No. PCT/EP2015/075796, filed on Nov. 5, 2015.

(30) Foreign Application Priority Data
Mar. 9, 2015 (DE) 102015204170.0

(51) Int. Cl. C11D 17/04; C11D 17/00; C11D 3/50

(52) U.S. Cl. CPC C11D 17/045; C11D 17/044; C11D 3/505; C11D 17/0039; C11D 17/043

(57) ABSTRACT

A portioned washing or cleaning agent in a container made of water-soluble material comprising at least two compartments which are separated from each other, wherein in at least one compartment a liquid washing or cleaning agent and in at least one further compartment, different herefrom, a powdery washing or cleaning agent is located which comprises core shell microcapsules in the form of microcapsule granulate, wherein the microcapsules comprise at least one additive in the core.

### FIELD OF THE INVENTION

The present invention generally relates to a portioned washing or cleaning agent in a container made of water-soluble material comprising at least two compartments which are separated from each other.

### BACKGROUND OF THE INVENTION

Nowadays, washing or cleaning agents can be obtained for the consumer in a variety of product formats. In addition to washing powder and granulate, this product comprises for example also cleaning agent concentrate in the form of extruded or pelletized compositions. These solid, concentrated or compacted product formats are characterized by a reduced volume per dosing unit and the costs of packaging and transport are thus reduced. In particular, in so doing, the washing or cleaning agent tablets also meet consumer need for simpler dosing.

Essentially, liquid washing agents and solid, powdery washing agents are frequently different. Liquid washing agents are increasingly what consumers want. These have the advantage that they do not leave behind any residues of washing agent on the textiles which appear unpleasant in particular on dark clothing. These are builders, zeolites (water softeners) and auxiliaries which do not occur in liquid washing agents. The disadvantage of liquid washing agents is that these do not contain any bleaching agent. This leads to specific stains which are usually removed by bleach (bleach-sensitive stains), such as fruit, coffee, red wine, tea or vegetable stains, not washing out as well as they do with solid washing agents. Additionally, a graying of white laundry is also to be observed. In order to counteract this, some liquid washing agents have optical brighteners added to them.

Heavy-duty washing agents do not usually contain bleaching agent, with the result that bleach-sensitive stains can be better removed and also graying of white laundry is prevented. At higher temperatures, heavy-duty washing agents also act on pathogens. The frequently occurring residues of washing agent can be avoided by precise dosing of the washing agent.

With liquid washing agents it is also disadvantageous that they frequently require a higher outlay on packaging (PE, PP or PET bottles) compared with highly-concentrated powder washing agents and the recycling is costlier than with folding boxes or simple plastic bags for powder.

In addition to the question of wash quality, the additional additives included in the washing or cleaning agents are also critical. Corresponding additives do not influence the cleaning performance of the washing agent itself but are frequently desired by the consumer. Corresponding additives are for example textile care products, disinfectants, skincare products or perfume or perfume oils. Such additives are frequently introduced into the washing agent in the form of microcapsules. These are deposited on textiles during washing and can then for example be released, during use of the textile, diffusively or by friction (capsules break when textile is used or worn). The introduction of microcapsules improves the performance of the additives compared with direct placement of the additive in the solid washing agent. This is in particular the case if the capsule surface is constructed such that it has a greater affinity with the substrate, the item of clothing or textile than the additive itself has.

In liquid washing agents, microcapsules are initially simpler to introduce but can be stabilized only—if at all—at great expense. Liquid washing agents need to have a yield point for this. In storage, there may also be so-called leaching of the ingredients of the microcapsules into the liquid washing agent phase by diffusion.

The introduction of encapsulated additives in the form of a slurry into solid, powdery washing agents poses problems to a person skilled in the art. Here, slurries are suspensions of microcapsules in a liquid, usually with water as main component. If the slurry to be introduced into the washing agent is sprayed thereupon, mechanical stresses or thermal stresses occur which the microcapsules cannot always withstand. As a result, there may be a release of the additives during the spraying procedure. The thus-released additive can in turn decompose unhindered or evaporate off, thus no longer being available for dispensing at the desired time.

If the slurry is shaken onto particulate materials and mixed at low or medium shear, the capsules usually remain intact, but lumps form due to agglomerations and this restricts the flowability and the pourability of the solid washing agent. However, a powdery solid washing agent used in multi-compartment pouches should have a good pourability for reasons of processing ability. If the powder agglutinates, the dosing device becomes blocked during the filling process.

Powdery washing agents into which microcapsules can also be introduced can also be supplied assembled. Here, portions dosed for a washing procedure are defined in corresponding water-soluble containers, so-called pouches or caps. Such pouches contain highly-concentrated solid washing agent used only in small doses. The dose is usually approximately 5 to 20 g per wash load. Compared with conventional solid washing agents, in which a dose of 50 to 100 g washing agent per wash load is conventionally used, clearly higher concentrations of microcapsules are needed in pouches in order to achieve a comparable effect. The correct quantity of washing agent ensured by pre-portioning can prevent or at least clearly reduce the occurrence of residues of washing agent on clothing.

One object of the present invention therefore consists of providing a washing or cleaning agent which substantially avoids the disadvantages of the prior art. Additionally, the washing or cleaning agent should include additives in the form of microcapsules in sufficient concentration still to be able to generate an effect in spite of the low dose per wash load. Surprisingly it has been shown that this object is achieved by a portioned washing or cleaning agent in a container made of water-soluble material comprising at least two compartments which are separated from each other, each of which compartment contains a powdery washing or cleaning agent which comprises microcapsules in the form of microcapsule granulates.

### BRIEF SUMMARY OF THE INVENTION

In a first embodiment, the present invention therefore relates to a portioned washing or cleaning agent in a container made of water-soluble material comprising at least two compartments which are separated from each other, wherein in at least one compartment a liquid washing or cleaning agent and in at least one further compartment, different herefrom, a powdery washing or cleaning agent is located which comprises core-shell microcapsules in the form of microcapsule granulate, wherein the microcapsules comprise at least one additive in the core.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

By introducing microcapsules in the form of microcapsule granulate, on the one hand, agglomeration of the solid, powdery washing or cleaning agent can be prevented. This also results in improved storage stability. The microcapsules are not damaged during production. Also, as the microcapsule granulate is contained exclusively in the solid, powdery phase of the portioned washing or cleaning agent, problems in the storage of microcapsules in the liquid phase of washing agents do not occur. It is also possible to introduce the additive in a sufficiently high concentration without the washing performance or the pourability of the powdery washing or cleaning agent being impaired as a result.

According to the invention, the level of microcapsules in the powdery washing or cleaning agent is in the range of from 0.1 to 2.5% a.s., in particular in the range of from 0.3 to 1.5% a.s. This quantity proportion is sufficient to make possible an effect in the washing liquor. Adding more would generally lead merely to an unnecessary increase in cost unnoticed by the consumer.

Unless otherwise indicated, percentages in the present invention relate to % a.s., thus to percentages of active substance or perfume. Here, active substance means the proportion which is active, thus effective, in the washing or cleaning agent. If ranges are indicated, the values included therebetween are thus also to be considered as being disclosed.

The microcapsules within the scope of the present invention are constructed from at least one shell and a core contained therein. In the core, the microcapsules comprise at least one additive which is considered advantageous by the consumer. Additives within the scope of the present invention are in particular textile care products such as plasticizers, agents for repelling and impregnating water and stains, bleaching agents, bleach activators, enzymes, silicon oils, antiredeposition agents, optical brighteners, graying inhibitors, run preventers, anti-crease agents, dye-transfer inhibitors, antimicrobial active ingredients, germicides, fungicides, antioxidants, antistatic agents, ironing auxiliaries, swelling agents and antislip agents, UV absorbers, cationic polymers, treatment agents for hard surfaces such as disinfectants, repellents to water and stains, shine promoters or preventers, hydrophobic or hydrophilic agents, film formers, skincare products or perfume (oil) or perfumes. According to the invention it is also possible that a plurality of additives which are different from one another are contained in the core of the microcapsules.

According to the invention, the core can both have a solid form and also be liquid or viscous. Waxy structures are also conceivable. It is possible that the at least one additive is contained substantially as pure substance in the capsule. Alternatively, such capsules in which the core is formed by a carrier mixed or impregnated with an additive, are also conceivable. Particularly preferred within the scope of the present invention are such capsules in which the core of the capsules is liquid, viscous or at least meltable at temperatures of 120° C. or less, in particular of 80° C. and below, particularly of 40° C. and below. This enables the provision of the additives at the desired time and enables a homogeneous distribution.

The shell of the capsules can be either stable or fragile. On the basis of already low mechanical stress, fragile capsules release additives contained in the core. Here, mechanical stress can be pressure (applied force), friction or shear stress. Advantageously, a pressure of less than 0.69 bar, in particular of less than 0.35 bar, preferably of 0.07 bar or less is enough to release the contained additive. Mechanically stable capsule shells are also conceivable. However, due to one or more other mechanisms, such as change in temperature, ionic strength or pH of the additive, these should be permeable. Stable capsule wall materials through which the additive(s) can diffuse are also possible. The additive(s) contained is (are) preferably released upon a change in pH, change in temperature, incidence of light, diffusion and/or upon sufficient mechanical stress. The release after the incidence of waves of a specific wavelength, such as for example (sun)light, is further preferred.

In a likewise preferred embodiment, the capsules are not thermally stable. If the capsules are exposed to a temperature of at least 70° C., preferably of at least 60° C., preferably of at least 50° C. and in particular of at least 40° C., the additive inside the capsules is released.

The terms “capsules” and “microcapsules” are used synonymously in the present invention. As microcapsules there are suitable those which have an average diameter X_{50.3} (volume average) of from 1 to 100 μm, preferably of from 5 to 80 μm, particularly preferably of from 10 to 50 μm and in particular of from 15 to 40 μm. The average particle diameter X_{50.3} is determined by sieving or by means of a Camsizer particle size analyzer from Retsch.

The capsules which can be used according to the invention can be water-soluble and/or water-insoluble capsules, but preferably are water-insoluble capsules. The advantage of the water insolubility of the capsules is that they can hereby outlast washing or cleaning and are thus capable of releasing the additive for the first time after the aqueous washing or cleaning process, for example during drying, just by increasing the temperature or by solar radiation while they are being worn, or by surface friction.

In particular it is preferred if the water-insoluble capsules are capsules which can be re-reamed, wherein the wall material (shell) contains preferably polyurethanes, polyolefins, polyamides, polyesters, polysaccharides, epoxy resins, silicon resins and/or polycondensation products of carbonyl compounds and compounds containing NH groups (such as for example melamine-urea-formaldehyde capsules or melamine-formaldehyde capsules or urea-formaldehyde capsules).

The term “capsules which can be re-reamed” means those capsules which, if they adhere to a surface treated therewith, can be opened or reamed by mechanical friction or by pressure, with the result that contents are released firstly due to a mechanical effect, for example if hands are dried using a hand towel on which such capsules are deposited. Preferably usable capsules have an average diameter X_{50.3} in the range of from 1 to 100 μm, preferably between 5 and 95 μm, in particular between 10 and 90 μm, for example between 10 and 80 μm. The shell of the capsules which surrounds the core or (filled) cavity has an average thickness in the range of from 0.01 to 30 μm, preferably of from 0.1 μm to 15 μm, in particular of from 0.5 μm to 8 μm, particularly preferably of from 0.5 μm to 3 μm. Capsules can in particular then be re-reamed if they lie within the ranges indicated above relating to the average diameter and relating to the average thickness.

Conventionally, high-molecular compounds such as for example protein compounds (such as for example gelatins, albumin, casein and others), cellulose derivatives (for example methyl cellulose, ethyl cellulose, cellulose acetate, cellulose nitrate, peroxycarboxylic and others) and above all also synthetic polymers (such as for example polyamides, polyethylene glycols, polyurethanes, epoxy resins and others) come into consideration as materials for capsules. Preferably, for example melamine-urea-formaldehyde or melamine-formaldehyde or urea-formaldehyde or polyacrylate copolymer serves as wall material (shell). Particularly preferably, according to the invention such capsules as described in US 20030125222 A1, DE 102008051799 A1 or WO 0149817 are used.

Preferred melamine-formaldehyde microcapsules are produced by condensing, in the presence of a protective colloid, melamine-formaldehyde precondensates and/or the C₁-C₄ alkyl ether thereof in water, by emulsifying a hydrophobic material which comprises at least one perfume and/or at least one oil. As hydrophobic material which can be used in the core material (i.a. as additive) for production are included all types of oils, such as perfumes, vegetable oils, animal oils, mineral oils, paraffins, silicon oils and other synthetic oils. Suitable protective colloids are e.g. cellulose derivatives, such as hydroxyethyl cellulose, carboxymethyl cellulose and methyl cellulose, polyvinylpyrrolidone, copolymers of N-vinylpyrrolidone, polyvinyl alcohols, partially hydrolyzed polyvinyl acetates, gelatin, gum arabic, xanthan gum, alginates, pectins, degraded starches, casein, polyacrylic acid, polymethacrylic acid, copolymerizates of acrylic acid and methacrylic acid, water-soluble polymers containing sulfonic acid groups, which polymers have a content of sulfoethyl acrylate, sulfoethyl methacrylate or sulfopropyl methacrylate, as well as polymerizates of N-(sulfoethyl)-maleinimide, 2-acrylamido-2-alkyl sulfonic acids, styrene sulfonic acids and formaldehyde as well as condensates of phenolsulfonic acids and formaldehyde.

It is preferred, according to the invention, to coat the surface of the microcapsules used according to the invention, completely or partly, with at least one cationic polymer. Correspondingly, there is suitable as cationic polymer for coating microcapsules at least one cationic polymer from Polyquaternium-1, Polyquaternium-2, Polyquaternium-4, Polyquaternium-5, Polyquaternium-6, Polyquaternium-7, Polyquaternium-8, Polyquaternium-9, Polyquaternium-10, Polyquaternium-11, Polyquaternium-12, Polyquaternium-13, Polyquaternium-14, Polyquaternium-15, Polyquaternium-16, Polyquaternium-17, Polyquaternium-18, Polyquaternium-19, Polyquaternium-20, Polyquaternium-22, Polyquaternium-24, Polyquaternium-27, Polyquaternium-28, Polyquaternium-29, Polyquaternium-30, Polyquaternium-31, Polyquaternium-32, Polyquaternium-33, Polyquaternium-34, Polyquaternium-35, Polyquaternium-36, Polyquaternium-37, Polyquaternium-39, Polyquaternium-43, Polyquaternium-44, Polyquaternium-45, Polyquaternium-46, Polyquaternium-47, Polyquaternium-48, Polyquaternium-49, Polyquaternium-50, Polyquaternium-51, Polyquaternium-56, Polyquaternium-57, Polyquaternium-61, Polyquaternium-69, Polyquaternium-86. Polyquaternium-7 is quite particularly preferred. The Polyquaternium nomenclature of the cationic polymers used within the scope of this application can be seen from the declaration of cationic polymers according to the International Nomenclature of Cosmetic Ingredients (INCI) declaration of cosmetic raw materials.

In order to obtain a microcapsule granulate, the microcapsules are brought into contact with a particulate carrier material. Within the scope of the present invention, carrier materials are those materials which have a very good absorption property. The carrier material preferably has an oil absorption capacity according to ISO 787-5 of at least 125 mL/100 g, preferably of at least 150 mL/100 g, particularly preferably of at least 175 mL/100 g and in particular of at least 200 mL/100 g. The oil absorption capacity serves as a measure of the absorption properties of a material. It is expressed in milliliters of oil per 100 g sample. A sample quantity of the particulate material under examination is placed on a plate for determination. Refined linseed oil is added, slowly, dropwise from a burette and, after each addition of oil, rubbed into the particulate material with a measuring scoop. The oil continues to be added for as long as solid and oil agglomerations have formed. From this point on, only a drop of refined linseed oil is added and basic distribution of oil with the measuring scoop takes place after the oil has been added. If a creamy paste is obtained, the addition of oil is stopped. The paste should then be distributed immediately without being broken or crumbled and should also still stick to the plate.

Preferred microcapsule granulates subsequently contain carrier material coated with microcapsules, wherein the carrier material has an oil absorption capacity according to ISO 787-5 of at least 125 mL/100 g, preferably of at least 150 mL/100 g, particularly preferably of at least 175 mL/100 g and in particular of at least 200 mL/100 g. The oil absorption coefficient of the pure carrier material is determined as described previously before being loaded with microcapsules.

The particulate carrier material can, within the scope of the present invention, be a single particulate component or a mixture of several different components. It is critical that, after heating for an hour in dry state, the sum of all carrier materials has an oil absorption capacity of 100 mL/100 g or more.

Regardless of the values of the oil absorption capacity, the BET surface according to DIN 66131 of the carrier material is preferably at least 10 m²/g, preferably at least 40 m²/g, in particular at least 70 m²/g, particularly at least 100 m²/g and particularly preferably at least 130 m²/g.

The average particle size X_{50.3} of the carrier material is preferably below 100 mm, preferably below 75 mm, more preferably below 50 mm, more preferably below 25 mm, in particular below 18 mm and in particular below 10 mm.

Preferably, the carrier material comprises amorphous aluminosilicates. This includes amorphously present compounds with different proportions of aluminum oxide (Al₂O₃) and silicon dioxide (SiO₂) which contain further metals. Preferably, the amorphous aluminosilicate used in the method according to the invention can be described by means of one of the following formulae (I) or (II):

x(M₂O)Al₂O₃y(SiO₂)w(H₂O) (formula I)

x(MeO)y(M₂O)Al₂O₃z(SiO₂)w(H₂) (formula II)

In formula (1), M stands for an alkali metal, preferably sodium or potassium. Particularly preferably, x assumes values of from 0.2 to 2.0, y values of from 0.5 to 10.0 and w all positive values including 0.

In formula (II), Me stands for an alkaline-earth metal, M for an alkali metal, more preferably x for values of from 0.001 to 0.1, y for values of from 0.2 to 2.0, z for values of from 0.5 to 10.0 and w for positive values including 0.

Furthermore, instead of the amorphous aluminosilicates or in addition thereto, the carrier material can comprise clays, preferably bentonite, alkaline-earth metal silicates, preferably calcium silicate, alkaline-earth metal carbonates, in particular calcium carbonate and/or magnesium carbonate and/or silicic acid.

Silicic acids are particularly preferably contained in the carrier material, wherein the name silicic acid here stands for a collective name for compounds of the general formula (SiO₂)m.nH₂O. Precipitated silicas are produced from an aqueous alkali silicate solution by precipitation with mineral acids. Colloidal primary particles form which agglomerate as the reaction continues and finally grow to aggregates. The powdery, voluminous molds have BET surfaces of from 30 to 800 m²/g.

The name pyrogenic silicic acids includes highly disperse silicic acids which are produced by flame hydrolysis. Silicon tetrachloride is broken down in an oxyhydrogen flame. On their surface, pyrogenic silicic acids possess clearly fewer OH groups than precipitation silicic acids. Due to the hydrophilia brought about by silanol groups, the synthetic silicic acids are frequently subjected to a chemical post-treatment method in which the OH groups for example react with organic chlorosilanes. Modified, for example hydrophobic surfaces, are thus produced, which surfaces substantially increased the engineering properties of the silicic acids. Also, chemically modified silicic acids come under the term “silicic acids” within the scope of the present invention.

Sipernat® 22 S, Sipernat® 50 or Sipernat® 50 S from Evonik (Germany) represent particularly advantageous embodiments, as well as spray-dried and then in particular ground silicic acids, as these have also proved very absorbent. However, the other silicic acids known in the prior art are likewise preferred.

Corresponding microcapsule granulates are described in detail in WO 201118959 A1. Reference is made here expressly in particular to the production method, the description of which begins on page 12.

Additives within the scope of the present invention are in particular:
textile care products such as plasticizers, agents for repelling and impregnating water and stains, bleaching agents, bleach activators, enzymes, silicon oils, antiredeposition agents, optical brighteners, graying inhibitors, run preventers, anti-crease agents, dye-transfer inhibitors, antimicrobial active ingredients, germicides, fungicides, antioxidants, antistatic agents, ironing auxiliaries, swelling agents and antislip agents, UV absorbers, cationic polymers,
treatment agents for hard surfaces such as disinfectants, repellents to water and stains, hydrophobic or hydrophilic agents, film formers,
skincare products or
perfume (oil) or perfumes.

A skincare compound is understood to mean a compound or a mixture of compounds which, when a surface thereof comes into contact with the washing or cleaning agent, adheres to the surface, and when the surface thereof comes into contact with the skin, provides the skin with an advantage compared with the surface which has not been treated with the washing or cleaning agent. This advantage can for example comprise the transfer of the skincare compound from the surface to the skin, a smaller transfer of water from the skin to the surface or a reduced friction on the surface of the skin by the treated surface.

The skincare compound is preferably hydrophobic, can be liquid or solid, and should be compatible with the other ingredients of the composition. The skincare compound can comprise, for example
a) waxes such as carnauba, spermaceti, beeswax, lanolin, derivatives thereof as well as mixtures thereof;
b) Plant extracts, for example vegetable oils such as avocado oil, olive oil, palm oil, palm kernel oil, rape-seed oil, linseed oil, soya oil, groundnut oil, coriander oil, castor oil, poppy oil, cacao oil, coconut oil, pumpkin seed oil, wheatgerm oil, sesame oil, sunflower oil, almond oil, macadamia nut oil, apricot kernel oil, hazelnut oil, jojoba oil or canola oil, chamomile, aloe vera or also green tea or plankton extract as well as mixtures thereof;
c) higher fatty acids such as lauric acid, myristic acid, palmitic acid, stearic acid, behenic acid, oleic acid, linoleic acid, linolenic acid, isostearic acid or polyunsaturated fatty acids;
d) higher fatty alcohols such as lauryl alcohol, cetyl alcohol, stearyl alcohol, oleyl alcohol, behenyl alcohol or 2-hexadecanol,
e) esters such as cetyl octanoate, lauryl lactate, myristyl lactate, cetyl lactate, isopropyl myristate, myristyl myristate, isopropyl palmitate, isopropyl adipate, butyl stearate, decyl oleate, cholesterol isostearate, glycerol monostearate, glycerol distearate, glycerol tristearate, alkyl lactate, alkyl citrate or alkyl tartrate;
f) hydrocarbons such as paraffins, mineral oils, squalane or squalene;
g) lipids;
h) vitamins such as vitamin A, C or E or vitamin alkyl esters;
i) phospholipids;
j) sunscreens such as octyl methoxycinnamate and butylmethoxybenzoylmethane;
k) silicon oils such as linear or cyclical polydimethyl siloxanes, amino-, alkyl-, alkylaryl- or aryl-substituted silicon oils and
l) mixtures thereof.

A perfume oil which can be used can contain individual perfume compounds, for example the synthetic products of esters, ethers, aldehydes, ketones, alcohols and hydrocarbons. Ester-type perfume compounds are for example benzyl acetate, phenoxyethyl isobutyrate, p-tert.-butyl cyclohexyl acetate, linalyl acetate, dimethyl benzyl carbinyl acetate (DMBCA), phenyl ethyl acetate, benzyl acetate, ethyl methyl phenyl glycinate, allyl cyclohexyl propionate, styrallyl propionate, benzyl salicylate, cyclohexyl salicylate, floramate, melusate and jasmecyclate. The ethers include for example benzyl ethyl ether and ambroxan, the aldehydes include for example linear alkanales having 8 to 18 C atoms, citral, citronellal, citronellyloxy acetaldehyde, cyclamen aldehyde, lilial and bourgeonal, the ketones include for example ionone, isomethyl ionone and methyl cedryl ketone, the alcohols include anethole, citronellol, eugenol, geraniol, linalool, phenylethyl alcohol and terpinol, the hydrocarbons include for example terpenes such as limonene and pinene. However, mixtures of different perfumes are preferably used which together produce an appealing fragrance of the formed perfume oil.

However, the perfume oils can also contain natural perfume mixtures as are accessible from plant sources, for example pine oil, citrus oil, jasmine oil, patchouli oil, attar or ylang-ylang oil. Also suitable are clary sage oil, chamomile oil, clove oil, melissa oil, mint oil, cinnamon leaf oil, lime blossom oil, juniper berry oil, vetiver oil, olibanum oil, galbanum oil and labdanum oil as well as orange blossom oil, neroli oil, orange peel oil and sandalwood oil.

Adhesive perfumes are for example the essential oils such as angelica root oil, anise oil, arnica blossom oil, basil oil, baya oil, champaca blossom oil, abies alba oil, abies alba cone oil, elemi oil, eucalyptus oil, fennel oil, pine needle oil, galbanum oil, geranium oil, ginger grass oil, guaiac wood oil, gurjun balsam oil, helichrysum oil, camphor oil, ginger oil, iris oil, cajaput oil, calamus oil, chamomile oil, camphor oil, cananga oil, cardamom oil, cassia oil, pine needle oil, copaiba balsam oil, coriander oil, spearmint oil, caraway oil, cumin oil, lemon grass oil, musk seed oil, myrrh oil, clove oil, neroli oil, niaouli oil, olibanum oil, oregano oil, palmarosa oil, patchouli oil, balsam Peru oil, petit grain oil, pepper oil, peppermint oil, allspice oil, pine oil, attar, rosemary oil, sandalwood oil, celery oil, star anise oil, thuja oil, thyme oil, verbena oil, vetiver oil, juniper berry oil, wormwood oil, wintergreen oil, ylang-ylang oil, hyssop oil, cinnamon oil, cinnamon leaf oil and cypress oil.

However, higher boiling or solid perfumes or natural or synthetic origin can be used within the scope of the present invention advantageously as adhesive perfumes or perfume mixtures. These compounds include for example the compounds named below, as well as mixtures thereof: ambrettolide, amylcinnamaldehyde, anethole, anisaldehyde, anise alcohol, anisole, anthranilic acid methyl ester, acetophenone, benzylacetone, benzaldehyde, benzoic acid ethylester, benzophenone, benzyl alcohol, borneol, bornyl acetate, bromostyrene, n-decylaldehyde, n-dodecylaldehyde, eugenol, eugenol methyl ether, eucalyptol, farnesol, fenchone, fenchyl acetate, geranyl acetate, geranyl formiate, heliotropin, heptine carboxylic acid methyl ester, heptaldehyde, hydroquinone dimethyl ether, hydroxy cinnamic aldehyde, hydroxy cinnamyl alcohol, indol, iron, isoeugenol, isoeugenol methyl ether, isosafrole, jasmone, camphor, carvacrol, carvone, p-cresol methyl ether, coumarin, p-methoxy acetophenone, methyl-n-amylketone, methyl-anthranilic acid methyl ester, p-methyl acetophenone, methyl chavicol, p-methyl quinoline, methyl naphthyl ketone, methyl-n-nonyl acetaldehyde, methyl-n-nonylketone, muscone, naphthol ethyl ether, naphthol methyl ether, nerol, nitrobenzene, n-nonylaldehyde, nonyl alcohol, n-octylaldehyde, p-oxy-acetophenone, pentadecanolide, phenylethyl alcohol, phenylacetaldehyde dimethyl acetal, phenylacetic acid, pulegone, safrole, salicylic acid isoamyl ester, salicylic acid methyl ester, salicylic acid hexyl ester, salicylic acid cyclohexyl ester, santalol, skatole, terpinol, thymuses, thymol, undelactone, vanillin, veratrum aldehyde, cinnamic aldehyde, cinnamyl alcohol, cinnamic acid, cinnamic acid ethyl ester, cinnamic acid benzyl ester. The highly volatile perfumes which can be used within the scope of the present invention include in particular the lower boiling perfumes of natural or synthetic origin, which can be used alone or in mixtures. Examples of highly volatile perfumes are allyl isothiocyanates (mustard oils), butanedione, limonene, linalool, linalyl acetate and -propionate, menthol, menthone, phellandrene, phenylacetaldehyde, terpinyl acetate, citral, citronellal.

Within the scope of an aroma-therapeutic effect, according to the invention, essential oils can also be used as benefit agents. Preferred essential oils are for example angelica fine—angelica archangelica, anise—pimpinella anisum, benzoin siam—styrax tonkinensis, cabreuva—myrocarpus fastigiatus, cajaput—melaleuca leucadendron, cistus—cistus ladaniferus, copaiba balsam—copaifera reticulata, costus root—saussurea discolor, silver fir needle—abies alba, elemi—canarium luzonicum, fennel—foeniculum dulce, spruce needle—picea abies, geranium—pelargonium graveolens, camphor leaves—cinnamonum camphora, immortelle—helichrysum ang., ginger extract—zingiber off, St. John's wort—hypericum perforatum, jojoba, German chamomile—matricaria recutita, blue chamomile—matricaria chamomilla, roman chamomile—anthemis nobilis, wild chamomile—ormensis multicaulis, wild carrot—daucus carota, mountain pine—pinus mugo, lavandin—lavandula hybrida, litsea cubeba—may chang, manuka—leptospermum scoparium, Lemon balm—melissa officinalis, maritime pine—pinus pinaster, myrrh—commiphora molmol, myrtle—myrtus communis, neem—azadirachta, niaouli—(MQV) Melaleuca quin. viridiflora, palmarosa—cymbopogon martini, patchouli—pogostemon patcohuli, perubalsam—myroxylon balsamum var. pereirae, ravensara aromatica, rosewood—aniba rosae odora, sage—salvia officinalis, horsetail—equisetaceae, yarrow—achillea millefolium, ribwort plantain—plantago lanceolata, Turkish sweetgum—liquidambar orientalis, tagetes—tagetes patula, narrow-leaved paperbark—melaleuca alternifolia, tolu balsam—myroxylon balsamum l., virginia cedar—juniperus virginiana, frankincense—boswellia carteri, silver fir—abies alba. The use of essential oils corresponds to a preferred embodiment of the invention.

In principle, all enzymes established in the prior art for textile treatment are suitable for use as additives. Preferably, this concerns one or more enzymes which, as the additive of a washing agent, can display a catalytic activity, in particular a protease, amylase, lipase, cellulase, hemicellulase, mannanase, pectin-splitting enztme, tannase, xylanase, xanthanase, β-glucosidase, carrageenase, perhydrolase, oxidase, oxidoreductase and mixtures thereof. Preferred suitable hydrolytic enzymes comprise in particular proteases, amylases, in particular α-amylases, cellulases, lipases, hemicellulases, in particular pectinases, mannanases, β-glucanases and mixtures thereof. Particularly preferred are proteases, amylases and/or lipases and mixtures thereof, and quite particularly preferred are proteases. In principle, these enzymes are of natural origin; proceeding from the natural molecules, improved variants which are correspondingly preferably used are available for use in washing or cleaning agents.

Preferred proteases are those of subtilisin type. Examples hereof are subtilisins BPN′ and Carlsberg, protease PB92, subtilisins 147 and 309, alkaline proteases from Bacillus lentus, subtilisin DY and the enzymes thermitase, proteinase K and proteases TW3 and TW7, which can be assigned to subtilases, but no longer to subtilisins in the narrower sense. Subtilisin Carlsberg is available in developed form under the trade names Alcalase® from Novozymes A/S, Bagsvaerd, Denmark. Subtilisins 147 and 309 are available under the trade names Esperase®, or Savinase® from Novozymes. The protease variants under the name BLAP® can be derived from the protease from Bacillus lentus DSM 5483. Further proteases which can be used are for example those available under the trade names Durazym®, Relase®, Everlase®, Nafizym®, Natalase®, Kannase® and Ovozyme® from Novozymes, those under the trade names Purafect®, Purafect® OxP, Purafect® Prime, Excellase® and Properase® from Genencor, one under the trade name Protosol® from Advanced Biochemicals Ltd., Thane, India, one under the trade name Wuxi® from Wuxi Snyder Bioproducts Ltd., China, those under the trade names Proleather® and Protease P® from Amano Pharmaceuticals Ltd., Nagoya, Japan, and one under the name Proteinase K-16 from Kao Corp., Tokyo, Japan. The proteases from Bacillus gibsonii and Bacillus pumilus are also particularly preferably used.

Examples of amylases which can be used according to the invention are the α-amylases from Bacillus licheniformis, from B. amyloliquefaciens or from B. stearothermophilus as well as the developments thereof, improved for use in washing or cleaning agents. The enzyme from B. licheniformis is available from Novozymes under the name Termamyl® and from Genencor under the name Purastar® ST. Development products of these α-amylases are available from Novozymes under the trade names Duramyl® and Termamyl® ultra, from Genencor under the name Purastar® OxAm and from Daiwa Seiko Inc., Tokyo, Japan, as Keistase®. The α-amylase of B. amyloliquefaciens is marketed by Novozymes under the name BAN®, and derived variants from the α-amylase of B. stearothermophilus under the names BSG® and Novamyl®, also from Novozymes. Furthermore, the α-amylase of Bacillus sp. A 7-7 (DSM 12368) and the cyclodextrin glucanotransferase (CGTase) of B. agaradherens (DSM 9948) can be emphasized for this purpose. Fusion products of all named molecules can likewise be used. The developments of α-amylase from Aspergillus niger and A. oryzae, available from Novozymes under the trade name Fungamyl®, are also suitable. Further advantageously usable commercial products are for example Amylase-LT®, as well as Stainzyme® or Stainzyme ultra® or Stainzyme plus®, the latter also available from Novozymes. Variants of these enzymes available also by point mutations can be used according to the invention.

Examples of lipases or cutinases which can be used according to the invention, which are contained in particular because of their triglyceride-splitting activities, but also in order to produce peracids from suitable precursors in situ, are the lipases available or developed originally from Humicola lanuginosa (Thermomyces lanuginosus), in particular those with the amino acid exchange D96L. For example, they are marketed by Novozymes under the trade names Lipolase®, Lipolase® Ultra, LipoPrime®, Lipozyme® and Lipex®. Furthermore, for example the cutinases can be used which have originally been isolated from Fusarium solani pisi and Humicola insolens. Likewise usable lipases are available from Amano under the names Lipase CE®, Lipase P®, Lipase B®, or Lipase CES®, Lipase AKG®, Bacillus sp. Lipase®, Lipase APO, Lipase M-AP® and Lipase AML®. From Genencor, for example the lipases or cutinases can be used, the starting enzymes of which have been isolated originally from Pseudomonas mendocina and Fusarium solanii. Further important commercial products to be mentioned are the preparations M1 Lipase® and Lipomax® marketed originally by Gist-Brocades and the enzymes under the names Lipase MY-30®, Lipase OF® and Lipase PLO marketed by Meito Sangyo KK, Japan, as well as the product Lumafast® from Genencor.

Cellulases may be present depending on the purpose as pure enzymes, as enzyme preparations or in the form of mixtures in which the individual components are advantageously supplemented in respect of their different performance aspects. These performance aspects include in particular the contributions of cellulase to the primary washing performance of the agent (cleaning performance), to the secondary washing performance of the agent (antiredeposition effect or graying inhibition), for reviving (tissue effect) or for bringing about a “stone washed” effect. A usable fungal, endoglucanase (EG)-rich cellulase preparation, or the developments thereof, is supplied by Novozymes under the commercial name Celluzyme®. The products Endolase® and Carezyme® likewise available from Novozymes are based on 50 kD-EG, or 43 kD-EG from H. insolens DSM 1800. Further commercial products from this company which can be used are Cellusoft®, Renozyme® and Celluclean®. Furthermore, for example 20 kD-EG from Melanocarpus, which are available from AB Enzymes, Finland, under the trade names Ecostones® and Biochips®, can be used. Further commercial products from AB Enzymes are Econase® and Ecopulp®. Further suitable cellulases are from Bacillus sp. CBS 670.93 and CBS 669.93, wherein Bacillus sp. CBS 670.93 is available from Genencor under the trade name Puradax®. Further commercial products from Genencor are “Genencor detergent cellulase L” and IndiAge® Neutra. Variants of these enzymes also available by point mutation can be used according to the invention. Particularly preferred cellulases are thielavia terrestris cellulase variants, cellulases from melanocarpus, in particular melanocarpus albomyces, EGIII-type cellulases from trichoderma reesei or variants available herefrom.

Furthermore, in particular for removing specific problem stains, further enzymes can be used which are summarized under the term hemicellulases. These include for example mannanases, xanthanlyases, xanthanases, xyloglucanases, xylanases, pullulanases, pectin-splitting enzymes and β-glucanases. The β-glucanase obtainable from Bacillus subtilis is available under the name Cereflo® from Novozymes. Hemicellulases particularly preferred according to the invention are mannanases which for example are marketed under the trade names Mannaway® by Novozymes or Purabrite® by Genencor. The pectin-splitting enzymes within the scope of the present invention are also those with the names pectinase, pectatlyase, pectinesterase, pectin demethylase, pectinmethoxylase, pectinmethyl esterase, pectase, pectinmethyl esterase, pectino esterase, pectinpectyl hydrolase, pectin depolymerase, endopolygalacturonase, pectolase, pectin hydrolase, pectin-polygalacturonase, endo-polygalacturonase, poly-α-1,4-galacturonide glycanohydrolase, endogalacturonase, endo-D-galacturonase, galacturane 1,4-α-galacturonidase, exopolygalacturonase, poly(galacturonate) hydrolase, exo-D-galacturonase, exo-D-galacturonanase, exopoly-D-galacturonase, exo-poly-α-galacturonosidase, exopolygalacturonosidase or exopolygalacturanosidase. Examples of enzymes suitable in this respect are for example available under the names Gamanase®, pectinex AR®, X-Pect® or Pectaway® from Novozymes, under the names Rohapect UF®, Rohapect TPL®, Rohapect PTE100®, Rohapect MPE®, Rohapect MA plus HC, Rohapect DA12L®, Rohapect 10L®, Rohapect B1L® from AB Enzymes and under the name Pyrolase® from Diversa Corp., San Diego, Calif., USA.

Among these enzymes those particularly preferred are the ones which are comparatively stable against oxidation or for example have been stabilized via point mutagenesis. These include in particular the already mentioned commercial products Everlase® and Purafect® OxP as examples of such proteases and Duramyl® as an example of such an α-Amylase.

It is preferred that an optical brightener is selected as additive from the substance classes of distyrylbiphenyls, stilbenes, 4,4′-diamino-2,2′-stilbene disulfonic acids of coumarin, of dihydro quinolinone, of 1,3-diarylpyrazoline, of naphthalic acid imides, of benzoxazole systems, of benzisoxazole systems, of benzimidazole systems, of pyrene derivatives substituted by heterocyclene, and mixtures thereof. These substance classes of optical brighteners have a high stability, a high light and oxygen resistance and a high affinity to fibers.

The following optical brighteners, which are selected from the group consisting of disodium-4,4′-bis-(2-morpholino-4-anilino-s-triazine-6-ylamino)stilbene disulfonate, disodium-2,2′-bis-(phenyl-styryl)disulfonate, 4,4′-Bis[(4-anilino-6-[bis(2-hydroxyethyl)amino]-1,3,5-triazine-2-yl)amino]stilbene-2,2′-disulfonic acid, hexasodium-2,2′-[vinylenebis[(3-sulphonato-4,1-phenylene)imino[6-(diethylamino)-,3,5-triazine-4,2-diyl]imino]]bis-(benzol-1,4-disulfonate), 2,2′-(2,5-thiophendiyl)bis[5-1,1-dim, can be incorporated well and stably as additives.

According to the invention, the capsules can have one of the named additives. However, it is also possible that the capsules comprise more than one additive. Preferably, the microcapsules within the scope of the present invention comprise at least one additive, selected from perfume, plasticizers, agents for repelling and impregnating water and stains, bleaching agent, bleach activators, enzymes, silicon oils, antiredeposition agents, optical brighteners, dye-transfer inhibitors, antimicrobial active ingredients, germicides, fungicides, antioxidants, antistatic agents, ironing auxiliaries, swelling agents and antislip agents, UV absorbers, cationic polymers, skincare products, or mixtures of at least two of these additives.

Quite particularly preferably, the additive is selected from at least one perfume.

It is preferred, according to the invention, if the powdery washing agent contains at most 10 wt.-%, preferably at most 5 wt.-%, quite particularly preferably at most 1 wt.-% unencapsulated perfumes, relative to the total quantity of perfume therein.

The liquid washing or cleaning agent which is a constituent of the portioned washing or cleaning agent according to the invention can be a conventional washing or cleaning agent known in the prior art. Corresponding liquid washing or cleaning agents comprise at least one surfactant, selected from non-ionic, anionic and amphoteric surfactants. Suitable liquid washing or cleaning agents are described for example in WO 2011117079 A1, WO 2013186170 A1 or WO 2013107579 A1, to which reference is made here expressly.

The powdery washing or cleaning agent comprises one or more washing or cleaning active substances, preferably selected from the group of builders, surfactants, polymers, bleaching agents, bleach activators, enzymes, corrosion inhibitors and disintegration aids.

The groups of surfactants include the non-ionic, anionic, cationic and amphoteric surfactants. According to the invention the solid, powdery washing or cleaning agent can comprise one or more of the named surfactants. Particularly preferably it comprises at least one or more anionic surfactants, which are contained preferably in a total quantity of from 20 to 50 wt.-%, in particular of from 25 to 35 wt.-%, in each case relative to the weight of the powdery agent.

The at least one anionic surfactant is preferably selected from the group comprising C9-13 alkylbenzene sulfonates, olefin sulfonates, C12-18 alkane sulfonates, ester sulfonates, alk(en)yl sulfates, fatty alcohol ether sulfates and mixtures thereof. It has been shown that these sulfonate and sulfate surfactants are particularly suitable for producing stable liquid compositions with a yield point. Liquid compositions which comprise as anionic surfactant C9-13 alkylbenzene sulfonates and fatty alcohol ether sulfates have particularly good dispersing properties. As sulfonate-type surfactants preferably C9-13 alkylbenzene sulfonates, olefin sulfonates, i.e. mixtures of alkene and hydroxy alkane sulfonates and disulfonates, as for example are obtained from C12-18 monoolefins with terminal or internal double bond by sulfonating with gaseous sulfur trioxide and then alkali or acid hydrolysis of sulfonation products, come into consideration. Also C12-18 alkane sulfonates and the esters of a sulfo fatty acids (ester sulfonates), for example the α-sulfonated methyl ester of hydrogenated palmitic, palm kernel or tallow fatty acids.

The alkali and in particular sodium salts of sulfuric acid semiesters of C12-C18 fatty acid alcohols, for example of coconut oil alcohol, tallow fat alcohol, lauryl, myristyl, cetyl or stearyl alcohol or of C10-C20 oxoalcohols and those semiesters of secondary alcohols of these chain lengths are preferred as alk(en)yl sulfates. For the purpose of washing technology, the C12-C16 alkyl sulfates and C12-C15 alkyl sulfates and C14-C15 alkyl sulfates are preferred. Also 2,3 alkyl sulfates are suitable anionic surfactants.

Also, fatty alcohol ether sulfates, such as sulfuric acid monoesters of straight-chained or branched C7-21 alcohols, such as 2-methyl-branched C9-11 alcohols with on average 3.5 mol ethylene oxide (EO) or C12-18 fatty acid alcohols with 1 to 4 EO, which C7-21 alcohols are ethoxylated with 1 to 6 mol ethylene oxide, are suitable.

It is preferred that the powdery washing or cleaning agent contains a mixture of sulfonate and sulfate surfactants. In a particularly preferred embodiment, the composition contains C9-13 alkylbenzene sulfonates and fatty alcohol ether sulfates as anionic surfactant.

In addition to the anionic surfactant, the composition can also contain soaps. Saturated and unsaturated fatty acid soaps, such as the salts of lauric acid, myristic acid, palmitic acid, stearic acid, (hydrogenated) erucic acid and behenic acid are suitable, in particular from natural fatty acids, for example coconut, palm kernel, olive oil or tallow fatty acids or derived soap mixtures, are suitable.

The anionic surfactants and the soaps can be present in the form of their sodium, potassium or magnesium or ammonium salts. Preferably, the anionic surfactants are present in the form of their sodium salts. Further preferred opposed ions for the anionic surfactants are also the protonated forms of choline, triethylamine, ethanolamine or methylethylamine.

In addition to the anionic surfactant, the composition can have also at least one non-ionic surfactant. The non-ionic surfactant comprises alkoxylated fatty alcohols, alkoxylated fatty acid alkyl esters, fatty acid amides, polyhydroxy fatty acid amides, alkylphenol polyglycol ethers, aminoxides, alkylpolyglucosides and mixtures thereof

Preferably alkoxylated, advantageously ethoxylated, in particular primary alcohols with preferably 8 to 18 C atoms and on average 4 to 12 mols ethylene oxide (EO) per mol alcohol are used as non-ionic surfactants, in which the alcohol residue can be linear or preferably methyl-branched in 2 position or can contain linear and methyl-branched residues in the mixture, as are conventionally present in oxo alcohol residues. However, in particular alcohol ethoxylates with linear residues made of alcohols of native origin with 12 to 18 C atoms, for example made of coco, palm, tallow fat or oleyl alcohol, and on average 5 to 8 EO per mol alcohol, are preferred. The preferred ethoxylated alcohols include for example C12-14 alcohols with 4 EO or 7 EO, C9-11 alcohol with 7 EO, C13-15 alcohols with 5 EO, 7 EO or 8 EO, C12-18 alcohols with 5 EO or 7 EO and mixtures thereof. The indicated degrees of ethoxylation represent statistical averages which can be an integer or a fractional number for a special product. Preferred alcohol ethoxylates have a concentrated homolog distribution (narrow range ethoxylates, NRE). In addition to these non-ionic surfactants, fatty alcohols with more than 12 EO can thus be used. Examples of this are tallow fatty alcohol with 14 EO, 25 EO, 30 EO or 40 EO. Also non-ionic surfactants, which contain EO and PO (propylene oxide) groups together in the molecule can be used according to the invention. Furthermore, a mixture of a (more strongly) branched ethoxylated fatty alcohol and an unbranched ethoxylated fatty alcohol, such as for example a mixture of a C16-18 fatty alcohol with 7 EO and 2 propylheptanol with 7 EO, are suitable. Particularly preferably, the washing, cleaning, post-treatment or washing auxiliary agents contains a C12-18 fatty alcohol with 7 EO or a C13-15 oxoalcohol with 7 EO as non-ionic surfactant.

The powdery washing or cleaning agent can also comprise one or more solvent. This can be water and/or non-aqueous solvent. Preferably, the composition contains water as main solvent. The composition can also comprise non-aqueous solvent. Suitable non-aqueous solvents comprise mono- or polyvalent alcohols, alkanolamines or glycol ethers. Preferably the solvents are selected from ethanol, n-propanol, i-propanol, butanolene, glycol, propanediol, butanediol, methylpropanediol, glycerol, diglycol, propyldiglycol, butyldiglycol, hexyleneglycol, ethyleneglycol methyl ether, ethyleneglycol ethyl ether, ethyleneglycol propyl ether, ethyleneglycol mono-n-butylether, diethyleneglycol methyl ether, diethylenglycol ethyl ether, propyleneglycol methyl ether, propyleneglycol ethyl ether, propyleneglycol propyl ether, dipropyleneglycol monomethyl ether, dipropyleneglycol monoethyl ether, methoxytriglycol, ethoxytriglycol, butoxytriglycol, 1-butoxyethoxy-2-propanol, 3-methyl-3-methoxybutanol, propyleneglycol-t-butylether, di-n-octylether and mixtures of these solvents.

According to the invention, the composition can also comprise builders and/or alkaline substances. For example, polymeric polycarboxylates are suitable as builders. These are for example the alkali metal salts of polyacrylic acid or of polymethacrylic acid, for example those with a relative molecular mass of 600 to 750,000 g/mol.

Suitable polymers are in particular polyacrylates which preferably have a molecular mass of 1,000 to 15,000 g/mol. In turn, from this group, the short-chained polyacrylates which have molar masses of 1,000 to 10,000 g/mol, and particularly preferably of from 1,000 to 5,000 g/mol, are preferred on the basis of their superior solubility.

Furthermore, copolymeric polycarboxylates, in particular those of acrylic acid with methacrylic acid, and acrylic acid or methacrylic acid with maleic acid, are suitable. The polymers can also contain allyl sulfonic acids, such as allyloxy benzene sulfonic acid and methallyl sulfonic acid, to improve water solubility.

As builders which can be contained in the composition according to the invention, there are in particular to be named also silicates, aluminosilicates (in particular zeolites), carbonates, salts of organic di- and polycarboxylic acids and mixtures of these substances.

Organic builders which furthermore may be present in the composition according to the invention are for example the polycarboxylic acids used in the form of their sodium salts, wherein by polycarboxylic acids, those carboxylic acids are meant which have more than one acid function. For example, these are citric acid, adipic acid, succinic acid, glutaric acid, malic acid, maleic acid, fumaric acid, saccharic acids, amino carboxylic acids, nitrilotriacetic acid (NTA), methylglycinediacetic acid (MGDA) and derivatives as well as mixtures thereof. Preferred salts are those of polycarboxylic acids such as citric acid, adipic acid, succinic acid, glutaric acid, malic acid, saccharic acids and mixtures thereof

Preferably, however, soluble builders, such as for example citric acid, or acryl polymers with a molar mass of 1,000 to 5,000 g/mol, are used.

Alkaline substances or wash alkalis are, within the scope of the present invention, chemicals for increasing and stabilizing the pH of the composition.

In a preferred embodiment, the powdery washing or cleaning agent according to the invention also comprises at least one enzyme. Suitable enzymes are the enzymes named before as additives. According to the invention it is also possible that several different enzymes are included. In a particularly preferred embodiment, the at least one enzyme is contained in a total quantity of from 0.001 to 4 wt.-%, more preferably of from 0.01 to 3 wt.-%, even more preferably of from 0.05 to 1.25 wt.-% and particularly preferably of from 0.2 to 1.0 wt.-%.

In a particularly preferred embodiment, the at least one enzyme is present as granulate. In particular, enzyme granulates are contained in a total quantity of from 4 to 15 wt.-%, preferably of from 7 to 12 wt.-%, in each case relative to 100 wt.-% of the total powdery washing or cleaning agent.

The powdery washing or cleaning agents according to the invention contain enzymes preferably in total quantities of 1×10⁻⁸ to 5 weight percent relative to active protein. Preferably, the enzymes are contained in a total quantity of from 0.001 to 4 wt.-%, more preferably of from 0.01 to 3 wt.-%, even more preferably of from 0.05 to 1.25 wt.-% and particularly preferably of from 0.2 to 1.0 wt.-%, in these powdery washing or cleaning agents.

Both the powdery and the liquid washing or cleaning agent can have one or more components described further in the prior art, such as for example optical brighteners, complexing agents, bleaching agents, bleach activators, antioxidants, enzyme stabilizers, antimicrobial active ingredients, graying inhibitors, antiredeposition agents, pH adjusters, electrolytes, laundry performance enhancers, vitamins, proteins, foam inhibitors and/or UV absorbers.

According to the invention, the portioned washing or cleaning agent is found in a container (pouch) made of water-soluble material. This container comprises at least two compartments which are spatially separated from each other (multi-compartment pouch). These compartments are separated from each other such that the contained liquid washing or cleaning agent and the powdery washing or cleaning agent do not come into contact with one another. This separation can for example take place by a wall which consists of the same material as the container.

The water-soluble or water-dispersible material can comprise a polymer, a copolymer or mixtures of these. Water-soluble polymers within the scope of the invention are such polymers which, at room temperature, are more than 2.5 wt.-% soluble in water.

Preferred water-soluble materials comprise preferably at least partly at least one substance from the group consisting of (acetalized) polyvinyl alcohol, polyvinylpyrrolidone, polyethylene oxide, gelatins, with sulfate, carbonate and/or citrate-substituted polyvinylalcohols, polyalkylene oxides, acrylamides, cellulose esters, cellulose ethers, cellulose amides, celluloses, polyvinylacetates, polycarboxylic acids and their salts, polyamino acids or peptides, polyamides, polyacrylamides, copolymers of maleic acid and acrylic acid, copolymers of acrylamides and (meth)acrylic acid, polysaccharides, such as for example starch or guar derivatives, gelatins and those under the INCI names Polyquaternium 2, Polyquaternium 17, Polyquaternium 18 and Polyquaternium 27. Particularly preferably, the water-soluble material is a polyvinyl alcohol.

In one embodiment of the invention, the water-soluble material comprises mixtures of different substances. Such mixtures enable the mechanical properties of the container to be adjusted and can influence the degree of water solubility.

The water-soluble material contains preferably at least one polyvinyl alcohol and/or at least one polyvinyl alcohol copolymer. “Polyvinyl alcohol” (PVAL or PVA for short, occasionally also PVOH) is the name for polymers of the general structure

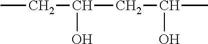

which also contain small quantities (approx. 2%) of structural units of the type

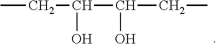

Commercially available polyvinyl alcohols available as white-gray powder or granulates with polymerization degrees in the range of from approx. 100 to 2500 (molar masses of approx. 4000 to 100,000 g/mol) have hydrolysis degrees of 98 to 99 mol % or 87 to 89 mol %, thus still contain a residual content of acetyl groups. The polyvinyl alcohols from the producer are characterized by the detail of the polymerization degree of the starting polymers, of the hydrolysis degree, of the saponification number or solution viscosity.

Depending on the degree of hydrolysis, polyvinyl alcohols are soluble in water and less strongly polar organic solvents (formamide, dimethyl formamide, dimethyl sulfoxide); they are not attacked by (chlorinated) hydrocarbons, esters, fats and oils. Polyvinyl alcohols are categorized as toxicologically harmless and are at least partially biodegradable. Water solubility can be reduced by post-treatment with aldehydes (acetalization), by complexing with Ni− or Cu salts or by treating with dichromats, boric acid or borax. The coatings of polyvinyl alcohol are extensively impenetrable to gases such as oxygen, nitrogen, helium, hydrogen, carbon dioxide, but allow water vapor to pass through.

Within the scope of the present invention it is preferred that the water-soluble material comprises, at least partly, a polyvinyl alcohol, the degree of hydrolysis of which is 70 to 100 mol %, preferably 80 to 90 mol %, particularly preferably 81 to 89 mol % and in particular 82 to 88 mol %. In a preferred embodiment, the water-soluble material contains up to at least 20 wt.-%, particularly preferably up to at least 40 wt.-%, quite particularly preferably up to at least 60 wt.-% and in particular up to at least 80 wt.-% of a polyvinyl alcohol, the degree of hydrolysis of which is 70 to 100 mol %, preferably 80 to 90 mol %, particularly preferably 81 to 89 mol % and in particular 82 to 88 mol %.

The above-described polyvinyl alcohols are widely available commercially, for example under the trade mark Mowiol® (Clariant). Within the scope of the present invention, particularly suitable polyvinyl alcohols are for example Mowiol 3-83, Mowiol® 4-88, Mowiol® 5-88, Mowiol® 8-88 and L648, L734, Mowiflex LPTC 221 ex KSE and compounds from Texas Polymers such as for example Vinex 2034.

Preferred polyvinyl alcohol copolymers comprise, in addition to vinyl alcohol, dicarboxylic acids as further monomer. Suitable dicarboxylic acids are itaconic acid, malonic acid, succinic acid and mixtures thereof, wherein itaconic acid is preferred.

Likewise preferred polyvinyl alcohol copolymers comprise, in addition to vinyl alcohol, an ethylenically unsaturated carboxylic acid, salt or ester thereof. Particularly preferably, such polyvinyl alcohol copolymers contain, in addition to vinyl alcohol, acrylic acid, methacrylic acid, acrylic acid ester, methacrylic acid ester or mixtures thereof

The water solubility of polyvinyl alcohol polymer can be changed by post-treatment with aldehydes (acetalization) or ketones (ketalization). Polyvinyl alcohols, which are acetalized or ketalized with the aldehyde or keto groups of saccharides or polysaccharides or mixtures thereof, have proved particularly preferred and, on the basis of their markedly good cold-water solubility, particularly advantageous.

Furthermore, the water solubility can change, and thus in targeted manner be adjusted to desired values, by complexing with Ni— or Cu salts or by treatment with dichromats, boric acid or borax. Films of PVAL are extensively impenetrable to gases such as oxygen, nitrogen, helium, hydrogen, carbon dioxide, but water vapor can pass through.

Also, in addition to polyvinyl alcohol, polymers selected from the group comprising acrylic acid-containing polymers, polyacryl amides, oxazolin polymers, polystyrene sulfonates, polyurethanes, polyesters, polyethers, polylactic acid and/or mixtures of the previous polymers can be added to the film material suitable as water-soluble material.

Suitable water-soluble films for use as water-soluble material of the water-soluble portion according to the invention are films which are marketed under the name Monosol M8630 from MonoSol LLC. Other suitable films include films with the name Solublon® PT, Solublon® KA, Solublon® KC or Solublon® KL from Aicello Chemical Europe GmbH or the films VF-HP from Kuraray.

Preferred water-soluble materials are wherein they comprise hydroxypropyl methylcellulose (HPMC) which has a degree of substitution (average number of methoxy groups per anhydroglucose unit of cellulose) of from 1.0 to 2.0, preferably of from 1.4 to 1.9, and a molar substitution (average number of hydroxy propoxyl groups per anhydroglucose unit of cellulose) of from 0.1 to 0.3, preferably or from 0.15 to 0.25.

Polyvinylpyrrolidones, PVP for short, are produced by radical polymerization of 1-vinylpyrrolidone. Commercially available PVPs have molar masses in the range of from approx. 2,500 to 750,000 g/mol and are provided as white, hygroscopic powder or as aqueous solutions.

Polyethylene oxides, PEOX for short, are polyalkylene glycols of the general formula

H—[O—CH₂—CH₂]ₙ—OH

which are produced technically by basically catalyzed polyaddition of ethylene oxide (oxirane) in mainly small quantities of water-containing systems with ethylene glycol as start molecule. Conventionally they have molar masses in the range of from approx. 200 to 5,000,000 g/mol, corresponding to degrees of polymerization n of from approx. 5 to >100,000. Polyethylene oxides possess an extremely low concentration of reactive hydroxy end groups and show only very weak glycol properties.

Gelatin is a polypeptide (molar mass: approx. 15,000 to >250,000 g/mol), which is obtained in particular by hydrolysis of the collagen contained in skin and bone under acid or alkali conditions. The amino acid composition of the gelatin corresponds largely to that of the collagen from which it has been obtained and varies, depending on its origin. The use of gelatin as water-soluble shell material is extremely widespread in particular in pharmacy in the form of hard or soft gelatin capsules. Gelatins in the form of films are used only sparingly because of the price which is high in comparison with the previously named polymers.

Water-soluble materials which comprise a polymer from the group of starch and starch derivatives, celluloses and cellulose derivatives, in particular methyl cellulose and mixtures thereof, are preferred within the scope of the present invention.

Starch is a homoglycan, wherein the glucose units are linked, α-glycosidically. Starch is made from two components of different molecular weight (MG): from approx. 20 to 30% straight-chained amylose (MG approx. 50,000 to 150,000) and 70 to 80% branch-chained amylopectin (MG approx. 300,000 to 2,000,000). In addition, small quantities of lipids, phosphoric acid and cations are included. Whereas, because of the bond in 1,4 position, the amylose forms long, spiral, intertwined chains with approximately 300 to 1,200 glucose molecules, the chain branches at the amylopectin after on average 25 glucose components by 1,6 bond to a branchlike structure with approximately 1,500 to 12,000 molecules of glucose. In addition to pure starch, starch derivatives are suitable for producing water-soluble containers within the scope of the present invention, which derivatives are available by polymer-analogous reactions from starch. Such chemically modified starches comprise for example products from esterification or etherifications in which hydroxy hydrogen atoms have been substituted. However, starches in which the hydroxy groups have been replaced by functional groups which are not bonded via an oxygen atom, can be used as starch derivative. In the group of starch derivatives for example there are alkali starches, carboxymethyl starch (CMS), starch ester and ethers and amino starches.

Pure cellulose has the formal gross composition (C₆H₁₀O₅) and represents, formally, a β-1,4-polyacetal of cellobiose which for its part is made from two molecules of glucose. Suitable celluloses consist of approx. 500 to 5,000 glucose units and consequently have average molar masses of 50,000 to 500,000. Within the scope of the present invention, cellulose derivatives which are available by polymer-analogous reactions of cellulose, can also be used as disintegration agents within the scope of the present invention. Such chemically modified celluloses comprise for example products from esterification or etherifications in which hydroxy hydrogen atoms have been substituted. However, celluloses in which the hydroxy groups have been replaced by functional groups which are not bonded via an oxygen atom, can also be used as cellulose derivative. In the group of cellulose derivatives there are for example alkali celluloses, carboxymethyl cellulose (CMC), cellulose ester and ether and amino celluloses.

The water-soluble material can have further additives. For example, these are plasticizers, such as for example dipropylene glycol, ethylene glycol or diethylene glycol, water or disintegrating agent.

Particularly preferably, polyvinyl alcohol is used as water-soluble material. On the one hand, this can be easily processed and obtained cost-effectively. Additionally, it is particularly well soluble in water and thus enables diverse possible applications of the produced container.

In a further embodiment, the present invention relates to the use of the washing or cleaning agent according to the invention for washing and/or cleaning of textiles. Textiles within the scope of the present invention are in particular textile sheet materials, such as for example items of clothing, bathing or laundry textiles. These can comprise natural and/or synthetic fibers, such as for example silk, linen, cotton, polyester, polyamide or acetate fibers. The fibers can be treated or untreated. Furthermore, such textile comprises sheet materials which consists of woven or nonwoven materials such as for example felts or nonwoven fleeces.

The washing or cleaning agent according to the invention is explained in the embodiments below.

### EXAMPLES

### Example 1

A granulate comprising a perfume microcapsule dispersion (187840 KM-1N2813 from Firmenich, Kerpen, Germany) and silicic acid as carrier material (Sipernat® 22 S, Evonik, Germany) was produced in a Lodige mixer according to the method described in WO 2010118959 A1.

The obtained granulate A1 had the following composition:
80 wt.-% capsule slurry 187840 KM-IN 2813
20 wt.-% Sipernat® 22 S

### Example 2

Powdery washing or cleaning agents A2 to A5 were produced in a tumble mixer according to the following compositions:

TABLE 1
powdery compositions

| | | | A4 (according to | |
|---|---|---|---|---|
| | A2 | A3 | the invention) | A5 |
| Component | % a.s. | % a.s. | % a.s. | % a.s. |
| Sodium (C₁₀-C₁₃) alkylbenzene sulfonate | 17.00 | 17.00 | 17.00 | 17.00 |
| Fatty alcohol sulfate (C₁₂-C₁₆) | 3.84 | 3.84 | 3.84 | 3.84 |
| Carboxymethylcellulose | 9.01 | 9.01 | 9.01 | 9.01 |
| Anionic polyester (soil release polyester, | 9.00 | 9.00 | 9.00 | 9.00 |
| TexCare ®SRA 300, Clariant, Germany) | | | | |
| Discoloration protection (Sokalan ®HP | 1.30 | 1.30 | 1.30 | 1.30 |
| 56 granulate, BASF) | | | | |
| Enzyme granulate | 10.73 | 10.73 | 10.73 | 10.73 |
| Soap | 2.60 | 2.60 | 2.60 | 2.60 |
| Sodium hydrogen carbonate | 19.96 | 17.96 | 17.46 | 19.96 |
| Zeolite | 0.40 | 0.40 | 0.40 | 0.40 |
| Sodium sulfate granulate | up to | up to | up to 100 | up to |
| | 100 | 100 | | 100 |
| Capsule slurry (187840 KMEIN2813, see | — | 2.00 | — | 2.00 |
| Ex. 1) | | | | |
| Capsule granulate A1 (from Ex. 1) | — | — | 2.0 | — |
| Silicic acid (Sipernat ® 22 S) | — | — | — | 0.5 |

### Example 3

The powder mixtures were subjected to an agglomeration test. 10 ml of each sample is placed in a hollow cylinder with a small measuring cylinder. The sample was weighted for 10 min with a punch and a weight of 3 kg, with the result that a molding is created. After 10 min, the testpiece was carefully pushed out of the mold and placed under a scale on which a balanced 1-L beaker was located. The scale is intended to be aligned such that only normal force acts on the testpiece.

The beaker was weighted with 40 mL such that it sits lightly on the testpieces placed below. Then, water was poured into the beaker at a constant rate of approximately 100 mL/5 s until the testpiece was crushed. The endpoint of the measurement was thus the quantity of water in the beaker when the testpiece was completely crushed. Measurement was stopped at 1000 ml and the measured value given at >1000 mL. The greater the measured value, the greater tendency the powder has to agglomerate.

The following results were obtained:

| Formulation | Quantity of water |
|---|---|
| A2 | 280 mL |
| A3 | >1000 mL |
| A4 (according to the | 680 mL |
| invention) | |
| A5 | 950 mL |

The compositions A3, A4 and A5 each contained the same quantity of capsule slurry. The spraying of the pure slurry (A3) leads to a strong agglomeration of the powder mixture. In contrast to this, the addition as granulate (A4, according to the invention) leads to an easily pourable product. The separated addition of slurry and carrier material (A5) provided a poorer result than A4 which was close to A3 in respect of the parameters of agglomeration and pourability.

### Example 4

A double-compartment pouch made of a PVA film (M8630, 88 μm) was produced with 7.5 g of the powder mixture A4 and a corresponding liquid washing agent (vide infra). The laundry washed with the product displayed a good rub and smell effect after drying.

The components of liquid composition L1 were stirred in sequence in a stirrer vessel.

TABLE 2
liquid composition

| | L1 |
|---|---|
| | [wt.-%] |
| C₁₁₋₁₃ alkylbenzene sulfonic acid | 23.0 |
| C₁₃₋₁₅ alkyl alcohol ethoxylated with 8 mol ethylene oxide | 24.0 |
| Glycerin | 9.0 |
| 2-aminoethanol | 6.8 |
| Ethoxylated polyethylene imine | 4.0 |
| C₁₂₋₁₈ fatty acid | 7.5 |
| Diethylene triamine-N,N,N′,N′,N″-penta(methylene | 3.5 |
| phosphonic acid), heptasodium salt (sodium DTPMP) | |
| 1,2-propylene glycol | 4.5 |
| Ethanol | 4.0 |
| Soil-release polymer from ethylene terephthalate and | 1.0 |
| polyethylene oxide-terephthalate | |
| Perfume | 1.7 |
| Water | up to 100 |

Pouch Product

For this purpose, a film M8630 from Monosol (88 μm) was stretched on a heatable mold with double cavity. The stretched film was heated for a period of 2400 ms at 105° C. and then pulled into the cavity by a vacuum. Consequently, 7.5 g of the powder mixture A4 was placed in the first cavity, pre-weighed, and then 16 mL of the liquid composition L1 from table 2 added to the second cavity by means of a syringe. Then, a top film (M8630, 90 μm) for sealing the cavities was placed on and heat-sealed to the first film by means of heat (150° C., 1000 ms). After the vacuum was removed, the portion was taken out of the cavity. A wall of the powder compartment of the portion was then perforated with a needle. As a result, surplus air escaped from the powder compartment of the portion and the film of the wall relaxed.

No blockage of the dosing system (filling channels) was observed when filling took place in an automated filling system and the same sequence of steps.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A portioned washing or cleaning agent in a container made of water-soluble material comprising at least two compartments which are separated from each other, wherein in at least one compartment a liquid washing or cleaning agent and in at least one further compartment, different herefrom, a powdery washing or cleaning agent is located which comprises core-shell microcapsules in the form of microcapsule granulate, wherein the microcapsules comprise at least one additive in the core.

2. The washing or cleaning agent according to claim 1, wherein the level of microcapsules in the powdery washing or cleaning agent is in the range of from 0.1 to 2.5%.

3. The washing or cleaning agent according to claim 1, wherein the microcapsules have an average diameter X_{50.3} of from 1 to 100 μm.

4. The washing or cleaning agent according to claim 1, wherein the additive is selected from perfume, plasticizers, agents for repelling and impregnating water and stains, bleaching agents, bleach activators, enzymes, silicon oils, antiredeposition agents, optical brighteners, graying inhibitors, run preventers, anti-crease agents, dye-transfer inhibitors, antimicrobial active ingredients, germicides, fungicides, antioxidants, antistatic agents, ironing auxiliaries, swelling agents and antislip agents, UV absorbers, cationic polymers, skincare products, or mixtures of at least two of these additives.

5. The washing or cleaning agent according to claim 1, wherein the additive is selected from at least one perfume.

6. The washing or cleaning agent according to claim 1, wherein the wall material (shell) of the microcapsules comprises melamine-urea-formaldehyde or melamine-formaldehyde or urea-formaldehyde or polyacrylate copolymer.

7. The washing or cleaning agent according to claim 1, wherein the microcapsules are coated, on the surface thereof, completely or partly with at least one cationic polymer.

8. The washing or cleaning agent according to claim 1, wherein the microcapsule granulate contains a carrier material coated with microcapsules, wherein the carrier material has an oil absorption capacity according to ISO 787-5 of at least 125 mL/100 g.

9. The washing or cleaning agent according to claim 8, wherein the average particle size X_{50.3} of the carrier material is below 100 mm.

10. The washing or cleaning agent according to claim 8, wherein the carrier material contains silicic acid.

11. The washing or cleaning agent according to claim 1, wherein the powdery washing or cleaning agent contains anion surfactant in a total quantity of from 20 to 50 wt. %, relative to the weight of the powdery agent.

12. The washing or cleaning agent according to claim 1, wherein the powdery washing or cleaning agent also contains at least one enzyme in a total quantity of from 0.001 to 4 wt.-%.

13. The washing or cleaning agent according to claim 12, wherein the at least one enzyme is present as granulate.

14. The washing or cleaning agent according to claim 1, wherein the powdery washing agent contains at most 10 wt.-% unencapsulated perfumes, relative to the total quantity of perfume therein.

15. The washing or cleaning agent according to claim 1, wherein the water-soluble material comprises polyvinyl alcohol.
